(19) United States
(12) Patent Application Publication
(10) Pub. No.: US 2026/0188936 A1
(43) Pub. Date: Jul. 2, 2026

(54) CHARGING CONNECTOR

(71) Applicant: Yazaki Corporation, Tokyo (JP)

(72) Inventors: Kenichi OKAMOTO, Shizuoka (JP); Akira HORIUCHI, Shizuoka (JP); Yoshiaki IKEDA, Shizuoka (JP); Takafumi OKUBO, Shizuoka (JP)

(73) Assignee: Yazaki Corporation, Tokyo (JP)

(21) Appl. No.: 19/430,455

(22) Filed: Dec. 23, 2025

(30) Foreign Application Priority Data
Dec. 26, 2024 (JP) 2024-230529

(51) Int. Cl. H01R 13/447; B60L 53/16

(52) U.S. Cl. CPC H01R 13/447; B60L 53/16

(57) ABSTRACT

A charging connector includes: a housing including a fitting portion having an opening into which a mating charging connector is fittable; and a cover configured to close the opening. The cover includes: a closing portion configured to close the opening; and a cylindrical portion extending in a cylindrical shape from the closing portion toward the fitting portion and inserted in the fitting portion in close contact with the fitting portion. The cylindrical portion has a slit opening at a distal end of the cylindrical portion and extending along an insertion direction of the cylindrical portion with respect to the fitting portion.

### CROSS-REFERENCE TO RELATED APPLICATIONS

The present application is based on and claims the benefit of priority from the prior Japanese Patent Application No. 2024-230529, filed on December 26, 2024, the entire contents of which are incorporated by reference herein.

### TECHNICAL FIELD

The present disclosure relates to a charging connector.

### BACKGROUND

JP 2024-60707 A describes a charging connector including a housing which has a socket as a fitting portion provided with an opening into which a mating charging connector is fittable and a cap which serves as a cover for closing the opening. In the charging connector, the cap includes a closing portion that closes the opening, and a cylindrical portion that extends in a cylindrical shape from the closing portion toward the socket and is inserted into the socket. In this charging connector, when the socket is not used, the opening is closed by the cap so that the mating charging connector is not fitted to the socket.

### SUMMARY

In the above charging connector, the cylindrical portion of the cover is inserted in close contact with the fitting portion. The cylindrical portion is inserted in close contact with the fitting portion, so that the cover can be held in the housing. On the other hand, in the charging connector, when the cylindrical portion is inserted into the fitting portion, the cylindrical portion and the fitting portion slide while being in close contact with each other, so that the insertion force is high and the assemblability of the cover with respect to the housing is low.

The present disclosure is directed to a charging connector capable of improving assemblability.

A charging connector in accordance with some embodiments includes: a housing including a fitting portion having an opening into which a mating charging connector is fittable; and a cover configured to close the opening. The cover includes: a closing portion configured to close the opening; and a cylindrical portion extending in a cylindrical shape from the closing portion toward the fitting portion and inserted in the fitting portion in close contact with the fitting portion. The cylindrical portion has a slit opening at a distal end of the cylindrical portion and extending along an insertion direction of the cylindrical portion with respect to the fitting portion.

According to the above configuration, it is possible to provide the charging connector capable of improving assemblability.

### BRIEF DESCRIPTION OF THE DRAWINGS

FIG. 1 is a perspective view of a charging connector according to the present embodiment.

FIG. 2 is a cross-sectional view taken along line II-II of FIG. 1.

FIG. 3 is a perspective view of a housing of the charging connector according to the present embodiment.

FIG. 4 is a front view of the housing of the charging connector according to the present embodiment.

FIG. 5 is a perspective view of a cover of the charging connector according to the present embodiment.

FIG. 6 is a rear view of the cover of the charging connector according to the present embodiment.

FIG. 7 is an enlarged side view of a main part of the cylindrical portion of the cover of the charging connector according to the present embodiment.

### DETAILED DESCRIPTION

Hereinafter, a charging connector 1 according to the present embodiment will be described in detail with reference to the drawings. Further, dimensional ratios in the drawings are exaggerated for convenience of description, and may be different from actual ratios.

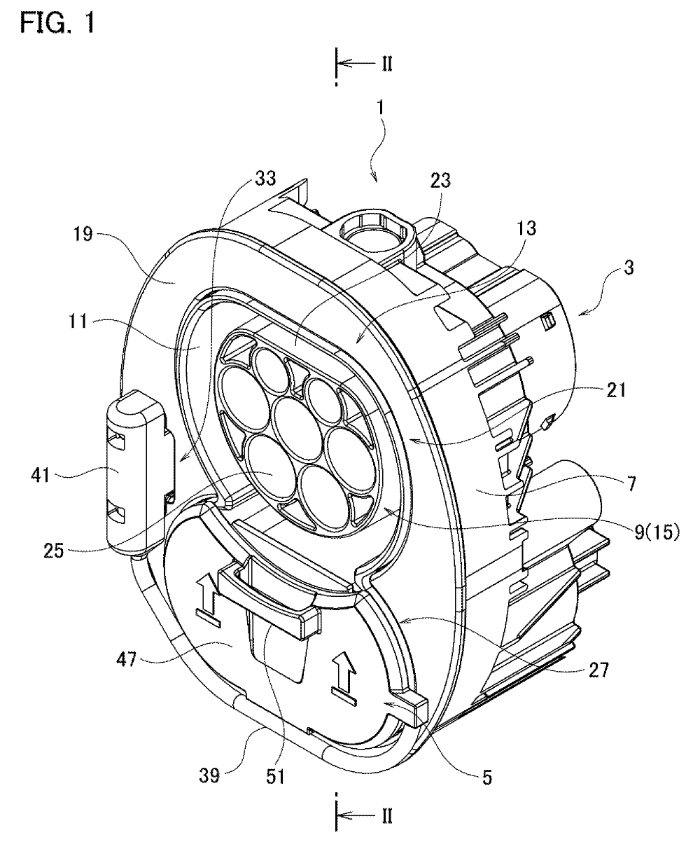

As illustrated in FIG. 1, the charging connector 1 according to the present embodiment is applied to, for example, a vehicle charger provided in a vehicle such as an electric car or a hybrid car. The charging connector 1 is electrically connected to a power source (not illustrated) such as a battery or a storage battery mounted on the vehicle. The charging connector 1 is fitted to a mating charging connector (not illustrated) provided in a power supply facility to charge the power source.

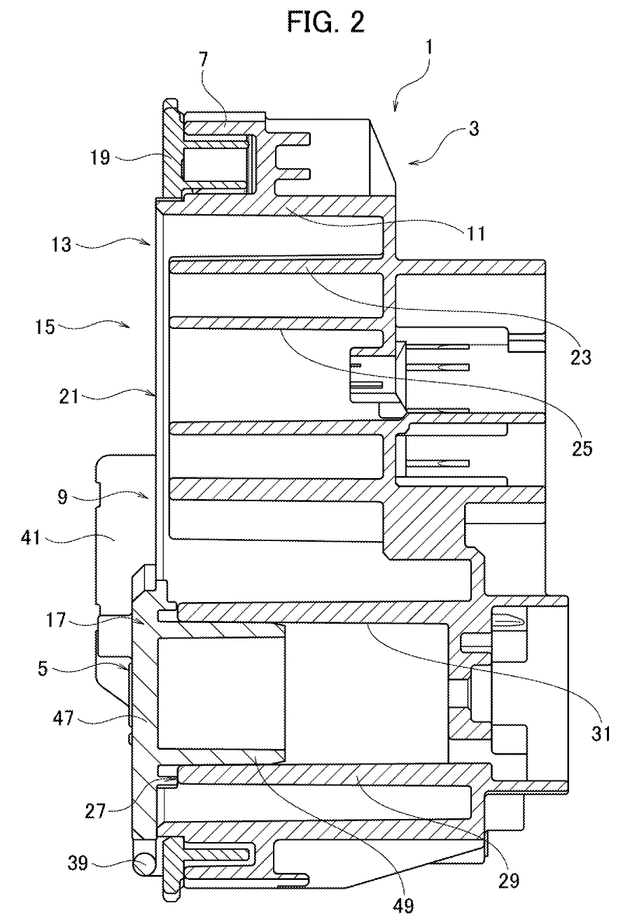

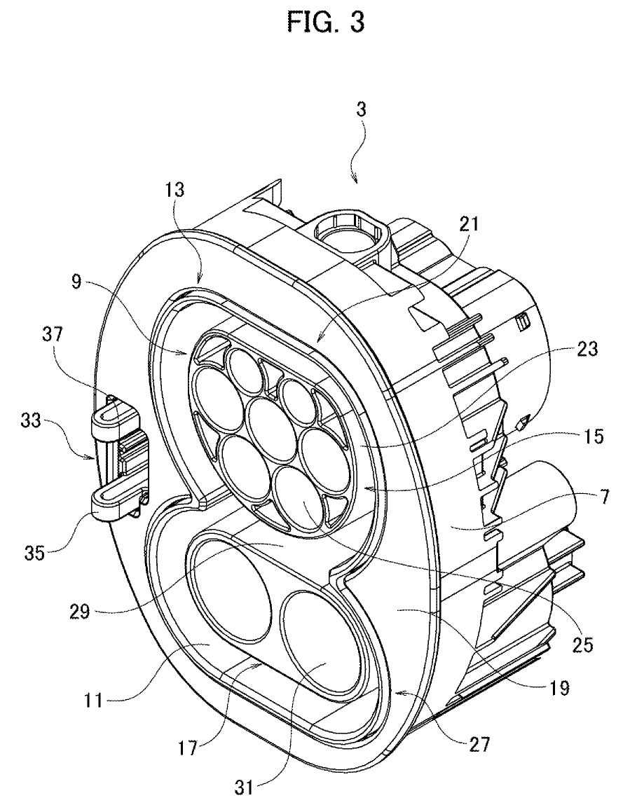

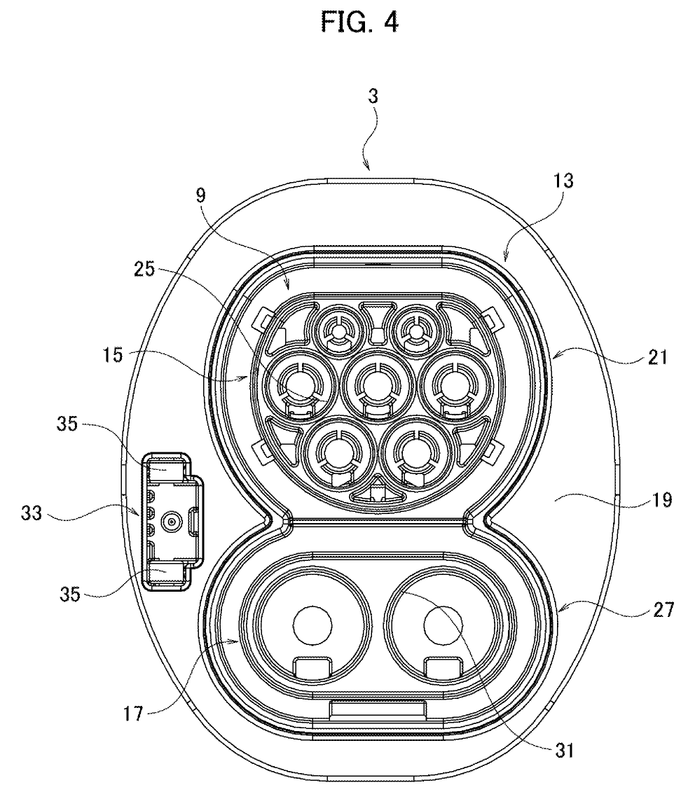

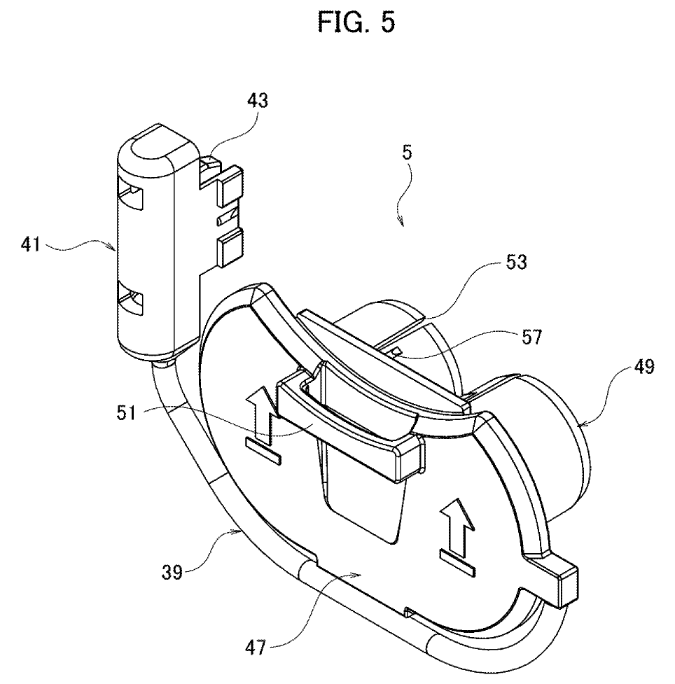

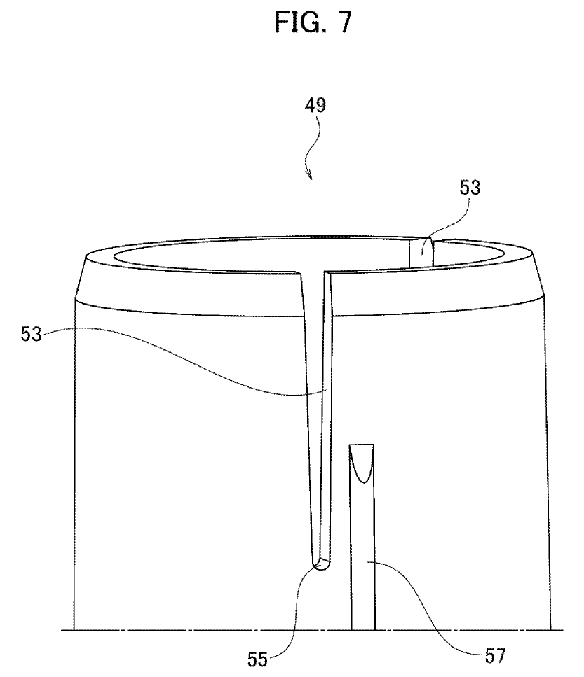

As illustrated in FIGS. 1 to 7, the charging connector 1 includes a housing 3 and a cover 5.

As illustrated in FIGS. 1 to 4, the housing 3 is made of, for example, an insulating material such as a synthetic resin. The housing 3 is formed with an outer wall 7 extending in a tubular shape along a fitting direction with the mating charging connector. A fitting portion 9 into which the mating charging connector is fittable is provided inside the outer wall 7. The fitting portion 9 has a fitting outer wall 11 extending in a cylindrical shape along a fitting direction with the mating charging connector. The opening on the fitting surface side of the fitting outer wall 11 is an opening 13 into which the mating charging connector is inserted.

The mating charging connector includes a normal charging connector (not illustrated) that charges a power source in a normal time and a quick charging connector (not illustrated) that charges a power source in a short time. Therefore, the inside of the fitting outer wall 11 of the housing 3 is partitioned into a normal fitting portion 15 that is fittable to the normal charging connector and a quick fitting portion 17 that is fittable to the quick charging connector. An opening formed between the outer wall 7 and the fitting outer wall 11 of the housing 3 is closed by a decorative cover 19 assembled to the housing 3 via an engaging portion.

The normal fitting portion 15 is arranged above the inside of the fitting outer wall 11. The opening 13 of the normal fitting portion 15 is a normal opening 21 into which the normal charging connector is insertable. Inside the normal fitting portion 15, a normal inner wall 23 extending in a cylindrical shape along a fitting direction with the normal charging connector is formed. Inside the normal inner wall 23, a plurality of (seven in the present embodiment) normal terminal accommodating chambers 25 extending in a cylindrical shape along a fitting direction with the normal charging connector are formed. Both sides in the length direction of the normal terminal accommodating chamber 25 are opened. The opening on one side in the length direction of the normal terminal accommodating chamber 25 is a connection opening into which a mating terminal (not illustrated) of the normal charging connector is inserted when the normal charging connector is fitted to the normal fitting portion 15. The opening on the other side in the length direction of the normal terminal accommodating chamber 25 is an insertion opening through which a normal charging terminal (not illustrated) is insertable into the normal terminal accommodating chamber 25. Inside each of the plurality of normal terminal accommodating chambers 25, the normal charging terminal is accommodated from the insertion opening.

The normal charging terminal is electrically connected to a terminal of an electric wire (not illustrated) electrically connected to a power source. The normal charging terminal is electrically connected to the mating terminal of the normal charging connector by fitting the normal charging connector to the normal fitting portion 15. By electrical connection between the normal charging terminal and the mating terminal, the power source is charged from the power supply facility in a normal time.

The quick fitting portion 17 is arranged at a lower position inside the fitting outer wall 11. The opening 13 of the quick fitting portion 17 is a quick opening 27 into which the quick charging connector is insertable. A quick inner wall 29 extending in a cylindrical shape along a fitting direction with the quick charging connector is formed inside the quick fitting portion 17. A plurality of (two in the present embodiment) quick terminal accommodating chambers 31 extending in a cylindrical shape along a fitting direction with the quick charging connector are formed inside the quick inner wall 29. Both sides in the length direction of the quick terminal accommodating chamber 31 are opened. The opening on one side in the length direction of the quick terminal accommodating chamber 31 is a connection opening into which a mating terminal (not illustrated) of the quick charging connector is inserted when the quick charging connector is fitted to the quick fitting portion 17. The opening on the other side in the length direction of the quick terminal accommodating chamber 31 is an insertion opening through which a quick charging terminal (not illustrated) is insertable into the quick terminal accommodating chamber 31. The quick charging terminal is accommodated in each of the plurality of quick terminal accommodating chambers 31 from the insertion opening.

The quick charging terminal is electrically connected to a terminal of an electric wire (not illustrated) electrically connected to a power source. The quick charging terminal is electrically connected to a mating terminal of the quick charging connector by fitting the quick charging connector to the quick fitting portion 17. The power source is charged from the power supply facility in a short time by electrical connection between the quick charging terminal and the mating terminal.

The normal charging terminal and the quick charging terminal accommodated in the housing 3 are held by the housing 3 by a rear holder (not illustrated) assembled to the housing 3, but the housing 3 may be provided with a locking lance engaged with the terminals.

The housing 3 is provided with a holding portion 33 that holds the cover 5 to the housing 3. The holding portion 33 is provided between the outer wall 7 and the fitting outer wall 11, and is arranged between the normal opening 21 and the quick opening 27. An opening is provided in a portion where the holding portion 33 of the decorative cover 19 is located. The holding portion 33 is provided with a pair of elastically deformable locking pieces 35 separated in the height direction of the housing 3 and extending along the fitting direction with the mating charging connector. The free ends of the pair of locking pieces 35 are exposed from the opening 13 (decorative cover 19). Each of the pair of locking pieces 35 is provided with a through hole 37 penetrating in the height direction of the housing 3. An opening edge of an end of the through hole 37 exposed from the opening 13 is an engaged portion.

The charging connector 1 having the normal fitting portion 15 and the quick fitting portion 17 in the housing 3 may not use the quick fitting portion 17, for example, when applied to a vehicle in which a large-capacity power source is not mounted. Therefore, the quick opening 27 of the quick fitting portion 17 is closed by the cover 5.

As illustrated in FIGS. 1, 2, and 5 to 7, the cover 5 is made of, for example, an insulating material such as synthetic resin. The cover 5 is provided with a cable 39 having one end formed of a member continuous with the cover 5. At the other end of the cable 39, a fixing portion 41 is provided as one member continuous with the cable 39. The fixing portion 41 is provided with an insertion portion 43 that can be inserted into the pair of locking pieces 35 of the holding portion 33 of the housing 3. An engaging portion 45 protruding toward the pair of locking pieces 35 is provided on an outer surface of the insertion portion 43 facing the pair of locking pieces 35. The engaging portion 45 is engaged with an engaged portion of the through hole 37 of the locking piece 35 in a state where the fixing portion 41 is assembled to the holding portion 33. The fixing portion 41 is held by the holding portion 33 by the engagement between the engaging portion 45 and the engaged portion. By causing the holding portion 33 to hold the fixing portion 41, the cover 5 can be held in the housing 3 via the cable 39 even in a state where the cover 5 is not arranged in the quick opening 27. The cover 5 includes a closing portion 47 and a cylindrical portion 49.

The closing portion 47 is formed in a flat plate shape extending along a planar direction parallel to the quick opening 27. The closing portion 47 is set to a size capable of covering the end surface of the fitting outer wall 11 where the quick opening 27 is located. The closing portion 47 closes the quick opening 27 in a state where the cover 5 is assembled to the housing 3. On the surface of a closing portion 47, for example, a grip portion 51 gripped by an operator is provided. A cylindrical portion 49 is provided on the back surface of the closing portion 47.

A plurality of (two in the present embodiment) cylindrical portions 49 are provided in the closing portion 47 to correspond to a plurality of (two in the present embodiment) quick terminal accommodating chambers 31. The cylindrical portion 49 is a member continuous with the closing portion 47 and extends in a cylindrical shape from the closing portion 47 toward the quick terminal accommodating chamber 31. A cylindrical portion 49 is inclined such that the diameter becomes slightly smaller on the distal end side than on the closing portion 47 side in order to facilitate insertion into the quick terminal accommodating chamber 31. A tapered surface is formed at a distal end of the cylindrical portion 49 in order to facilitate insertion into the quick terminal accommodating chamber 31. An outer diameter of the cylindrical portion 49 is set to be equal to an inner diameter of the quick terminal accommodating chamber 31. The cylindrical portion 49 is inserted into the quick terminal accommodating chamber 31 in a state where the cover 5 is assembled to the housing 3. At this time, since the outer diameter of the cylindrical portion 49 and the inner diameter of the quick terminal accommodating chamber 31 are set to be equal, the outer surface of the cylindrical portion 49 is brought into close contact with the inner surface of the quick terminal accommodating chamber 31 so as to be press-fitted. The cover 5 can be held by the housing 3 by the close contact between the outer surface of the cylindrical portion 49 and the inner surface of the quick terminal accommodating chamber 31.

Since the outer diameter of the cylindrical portion 49 is set to be equal to the inner diameter of the quick terminal accommodating chamber 31, the insertion force when the cylindrical portion 49 is inserted into the quick terminal accommodating chamber 31 is high, and the assemblability is deteriorated. Therefore, the cylindrical portion 49 is provided with a slit 53.

The slit 53 is opened at the distal end of the cylindrical portion 49 and extends along the insertion direction of the cylindrical portion 49 with respect to the quick terminal accommodating chamber 31. By providing the slit 53 in the cylindrical portion 49, the cylindrical portion 49 can be elastically deformed so as to reduce the outer diameter. Therefore, the insertion force of the cylindrical portion 49 with respect to the quick terminal accommodating chamber 31 can be reduced by the elastic deformation of the cylindrical portion 49, and the assemblability can be improved. The slit 53 is set such that the width gradually increases toward the opening. Therefore, the distal end side of the cylindrical portion 49 is more likely to be elastically deformed, the distal end of the cylindrical portion 49 can be easily inserted into the quick terminal accommodating chamber 31, and the assemblability can be further improved. The bottom portion 55 located on the side opposite to the opening of the slit 53 is arranged in the vicinity of the intermediate portion in the length direction of the cylindrical portion 49, located on the distal end side of the cylindrical portion 49 with respect to the closing portion 47. By arranging the bottom portion 55 of the slit 53 in the vicinity of the intermediate portion of the cylindrical portion 49, the rigidity of the closing portion 47 side of the cylindrical portion 49 can be increased and the shape of the cylindrical portion 49 can be maintained. Therefore, the close contact between the closing portion 47 side of the cylindrical portion 49 and the quick terminal accommodating chamber 31 can be stabilized, and the cover 5 can be stably held in the housing 3.

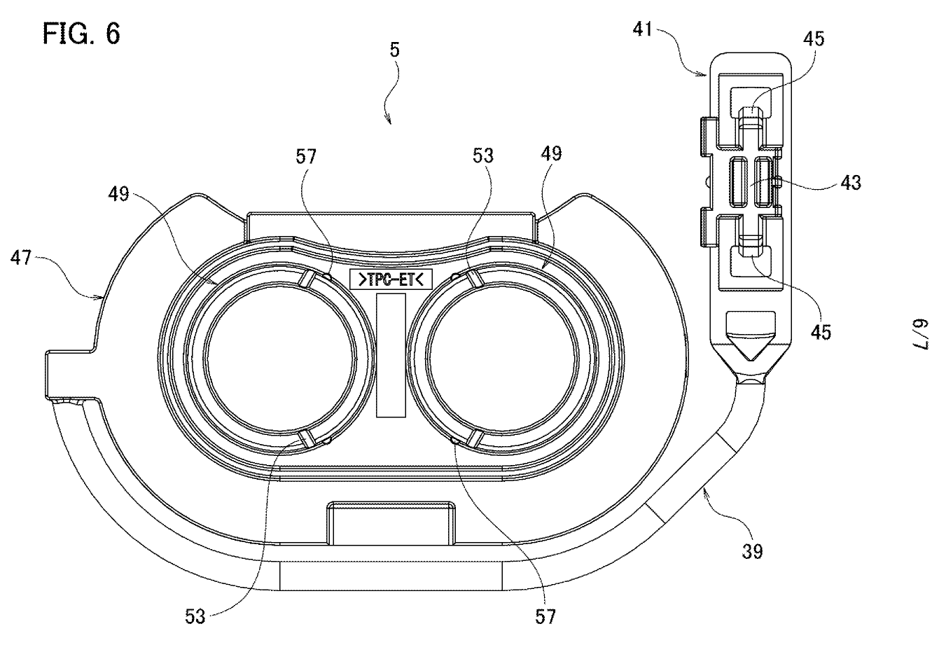

The plurality of (two in the present embodiment) slits 53 are provided in the circumferential direction of the cylindrical portion 49. The interval between the adjacent slits 53 in the circumferential direction of the cylindrical portion 49 is set differently. Here, as illustrated in FIG. 6, the interval on the right side is set to be narrower than the interval on the left side. By making the interval between the adjacent slits 53 different, it is possible to make a difference in elastic deformation at the circumferential portion of the cylindrical portion 49. For example, in the circumferential portion of the cylindrical portion 49, the portion on the right side in FIG. 6 is more likely to be elastically deformed than the portion on the left side in FIG. 6. By providing a difference in the elastic deformation of the cylindrical portion 49, it is possible to adjust the insertion force by, for example, applying an appropriate insertion force, and to further improve the assemblability.

A plurality of (two in the present embodiment) press-fit ribs 57 to be press-fitted into the inner surface of the quick terminal accommodating chamber 31 are provided on the outer surface of the cylindrical portion 49 provided with the slit 53. The press-fit rib 57 protrudes from the outer surface of the cylindrical portion 49 and extends along the insertion direction of the cylindrical portion 49 from the closing portion 47 toward the distal end side of the cylindrical portion 49. A tapered surface is formed at the distal end of the press-fit rib 57 in the insertion direction in order to facilitate insertion into the quick terminal accommodating chamber 31. The press-fit rib 57 is arranged adjacent to the slit 53 at different positions in the circumferential direction of the cylindrical portion 49 with respect to the slit 53. By providing the press-fit rib 57 in the cylindrical portion 49, press-fitting of the cylindrical portion 49 into the quick terminal accommodating chamber 31 can be strengthened, and the cover 5 can be stably held in the housing 3. In addition, by arranging the press-fit rib 57 adjacent to the slit 53, the rigidity of the portion of the cylindrical portion 49 that is easily elastically deformed can be increased, and the shape of the cylindrical portion 49 can be stably maintained.

Such a charging connector 1 includes the housing 3 having the fitting portion 9 in which the opening 13 into which a mating charging connector is fittable is formed, and the cover 5 that closes the opening 13. The cover 5 includes the closing portion 47 that closes the opening 13, and the cylindrical portion 49 that extends in a cylindrical shape from the closing portion 47 toward the fitting portion 9 and is inserted in close contact with the fitting portion 9. The cylindrical portion 49 is provided with the slit 53 which is opened at the distal end of the cylindrical portion 49 and extends along the insertion direction of the cylindrical portion 49 with respect to the fitting portion 9.

By providing the slit 53 in the cylindrical portion 49, the cylindrical portion 49 can be elastically deformed so as to change its diameter. Therefore, the cylindrical portion 49 is elastically deformed, so that the insertion force of the cylindrical portion 49 with respect to the fitting portion 9 can be reduced, and the assemblability can be improved.

Therefore, in such a charging connector 1, assemblability can be improved.

The slit 53 is gradually widened toward the opening.

Therefore, the distal end side of the cylindrical portion 49 is more likely to be elastically deformed, the distal end of the cylindrical portion 49 can be easily inserted into the fitting portion 9, and the assemblability can be further improved.

In the slit 53, the bottom portion 55 located on the opposite side of the opening is arranged on the distal end side of the cylindrical portion 49 with respect to the closing portion 47.

Therefore, the rigidity of the closing portion 47 side of the cylindrical portion 49 can be increased to maintain the shape of the cylindrical portion 49, the close contact between the closing portion 47 side of the cylindrical portion 49 and the fitting portion 9 can be stabilized, and the cover 5 can be stably held in the housing 3.

A plurality of slits 53 are provided in the circumferential direction of the cylindrical portion 49. The adjacent slits 53 are set to have different intervals in the circumferential direction of the cylindrical portion 49.

By making the interval between the adjacent slits 53 different, it is possible to make a difference in elastic deformation at the circumferential portion of the cylindrical portion 49. Therefore, it is possible to adjust the insertion force by, for example, applying an appropriate insertion force, and further improve the assemblability.

The cylindrical portion 49 is provided with a press-fit rib 57 press-fitted into the fitting portion 9.

Therefore, press-fitting of the cylindrical portion 49 into the fitting portion 9 can be strengthened, and the cover 5 can be stably held in the housing 3.

The press-fit rib 57 is arranged adjacent to the slit 53 at different positions in the circumferential direction of the cylindrical portion 49 with respect to the slit 53.

Therefore, the rigidity of the portion of the cylindrical portion 49 that is easily elastically deformed can be increased, and the shape of the cylindrical portion 49 can be stably maintained.

In the charging connector 1 of the present embodiment, the cylindrical portion 49 is inserted into the quick terminal accommodating chamber 31 of the quick fitting portion 17, but the present invention is not limited thereto, and the quick inner wall 29 of the quick fitting portion 17 may be inserted into the cylindrical portion 49. In this case, the press-fit rib 57 may be provided on the inner surface of the cylindrical portion 49.

Although two slits 53 are provided, the present invention is not limited thereto, and three or more slits 53 may be provided. Similarly, two press-fit ribs 57 are provided, but the present invention is not limited thereto, three or more press-fit ribs 57 may be provided, and the number of press-fit ribs 57 may not be the same as the number of slits 53.

Although the cable 39 is integrally provided on the cover 5, the present invention is not limited thereto, and only the cover 5 may be assembled to the housing 3 without providing the cable 39 on the cover 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charging connector comprising:
a housing including a fitting portion having an opening into which a mating charging connector is fittable; and
a cover configured to close the opening, wherein
the cover includes:
a closing portion configured to close the opening; and
a cylindrical portion extending in a cylindrical shape from the closing portion toward the fitting portion and inserted in the fitting portion in close contact with the fitting portion, and
the cylindrical portion has a slit opening at a distal end of the cylindrical portion and extending along an insertion direction of the cylindrical portion with respect to the fitting portion.

2. The charging connector according to claim 1, wherein the slit is gradually widened toward the opening.

3. The charging connector according to claim 1, wherein a bottom portion of the slit located on a side opposite to the opening is arranged on a distal end side of the cylindrical portion with respect to the closing portion.

4. The charging connector according to claim 1, wherein
a plurality of the slits are provided in a circumferential direction of the cylindrical portion, and
the adjacent slits have different intervals in the circumferential direction of the cylindrical portion.

5. The charging connector according to claim 1, wherein the cylindrical portion has a press-fit rib press-fitted into the fitting portion.

6. The charging connector according to claim 5, wherein the press-fit rib is arranged adjacent to the slit at different positions in the circumferential direction of the cylindrical portion with respect to the slit.
